(19) United States
(12) Patent Application Publication
(10) Pub. No.: US 2017/0031649 A1
(43) Pub. Date: Feb. 2, 2017

(54) AUDIO DEVICE AND MENU DISPLAY METHOD OF AUDIO DEVICE

(71) Applicant: FUJITSU TEN LIMITED, Kobe-shi (JP)

(72) Inventor: Akihiro TOMIYORI, Kobe-shi (JP)

(73) Assignee: FUJITSU TEN LIMITED, Kobe-shi (JP)

(21) Appl. No.: 15/174,347

(22) Filed: Jun. 6, 2016

(30) Foreign Application Priority Data
Jul. 29, 2015 (JP) 2015-149761

(51) Int. Cl. G06F 3/16; G06F 3/0484; G06F 3/0481; G06F 3/0482

(52) U.S. Cl. CPC G06F 3/165; G06F 3/0482; G06F 3/04842; G06F 3/04817

(57) ABSTRACT

There is provided an audio device. A connection detecting unit is configured to detect establishment of a connection for communication with a portable audio device having a display unit capable of displaying choices noted in characters. A character acquiring unit is configured to acquire notation characters of the choices from the portable audio device while the connection detecting unit detects the establishment of the connection for communication. A display unit is configured to display a menu screen including areas for displaying choices. A display control unit is configured to cause the display unit to display the notation characters acquired by the character acquiring unit, in the areas.

### CROSS-REFERENCE TO RELATED APPLICATIONS

This application is based on and claims priority from Japanese Patent Application No. 2015-149761 filed on Jul. 29, 2015.

### TECHNICAL FIELD

The present invention relates to an audio device and a menu display method of the audio device.

### BACKGROUND

In the related art, there is a technology called mirroring. This technology is for connecting a first device and a second device such that the same screen as a screen which is displayed on a display unit of the second device is displayed on a display unit of the first device, whereby it is possible to use the first device to operate the second device.

For example, in Patent Document 1, there is disclosed an in-vehicle device having a mirroring function such that if a portable terminal is connected to the in-vehicle device, the same menu screen as a menu screen of the portable terminal is displayed a display unit of the in-vehicle device, whereby it is possible to use the menu screen of the display unit of the in-vehicle device to operate the portable terminal.

According to this in-vehicle device, for example, in a case where the in-vehicle device is an audio device, if a user connects a portable audio device to the in-vehicle device, in the vehicle, the user can enjoy music stored in the portable audio device by operating the in-vehicle device.

Patent Document 1: Japanese Patent Application Publication No. 2015-41245A

Although audio devices having the mirroring function are convenient, the cost of them is higher than that of audio devices having no mirroring function.

Meanwhile, there is also a method of displaying a menu screen unique to an audio device, on a display unit of the audio device, such that it is possible to use the unique menu screen to operate a portable audio device. However, this method gives a feeling of discomfort to a user accustomed to operating the menu screen of the portable audio device.

### SUMMARY

It is therefore an object of the present invention to provide a low-cost audio device which a user accustomed to using a portable audio device can operate without feeling discomfort even when the portable audio device is connected to the audio device, and a menu display method of the audio device.

According to an aspect of the embodiments of the present invention, there is provided an audio device comprising: a connection detecting unit configured to detect establishment of a connection for communication with a portable audio device having a display unit capable of displaying choices noted in characters; a character acquiring unit configured to acquire notation characters of the choices from the portable audio device while the connection detecting unit detects the establishment of the connection for communication; a display unit configured to display a menu screen including areas for displaying choices; and a display control unit configured to cause the display unit to display the notation characters acquired by the character acquiring unit, in the areas.

According to the embodiment, it is possible to provide a low-cost audio device which a user accustomed to using a portable audio device can operate without feeling discomfort even when the portable audio device is connected to the audio device, and a menu display method of the audio device.

### BRIEF DESCRIPTION OF THE DRAWINGS

In the accompanying drawings:

FIG. 1 is an explanatory view illustrating a menu display method of an audio device according to an embodiment;

FIG. 2 is a functional block diagram illustrating the configuration of the audio device according to the embodiment;

FIG. 3 is an explanatory view of an acquired-notation-character table according to the embodiment;

FIG. 4 is an explanatory view of an initial-notation-character table according to the embodiment;

FIG. 5 is a flow chart illustrating a process which is performed by a control unit of the audio device according to the embodiment;

FIG. 6 is a functional block diagram illustrating the configuration of an audio device according to a modification of the embodiment; and

FIG. 7 is an explanatory view illustrating reproduction history information which is stored in the audio device according to the modification of the embodiment.

### DETAILED DESCRIPTION OF THE EMBODIMENTS

Hereinafter, an audio device and a menu display method of the audio device according to an embodiment will be described in detail with reference to the accompanying drawings. However, the present invention is not limited by the following embodiment. Also, although an in-vehicle audio device 1 will be described below as an example, the audio device 1 according to the embodiment is not limited to an in-vehicle device.

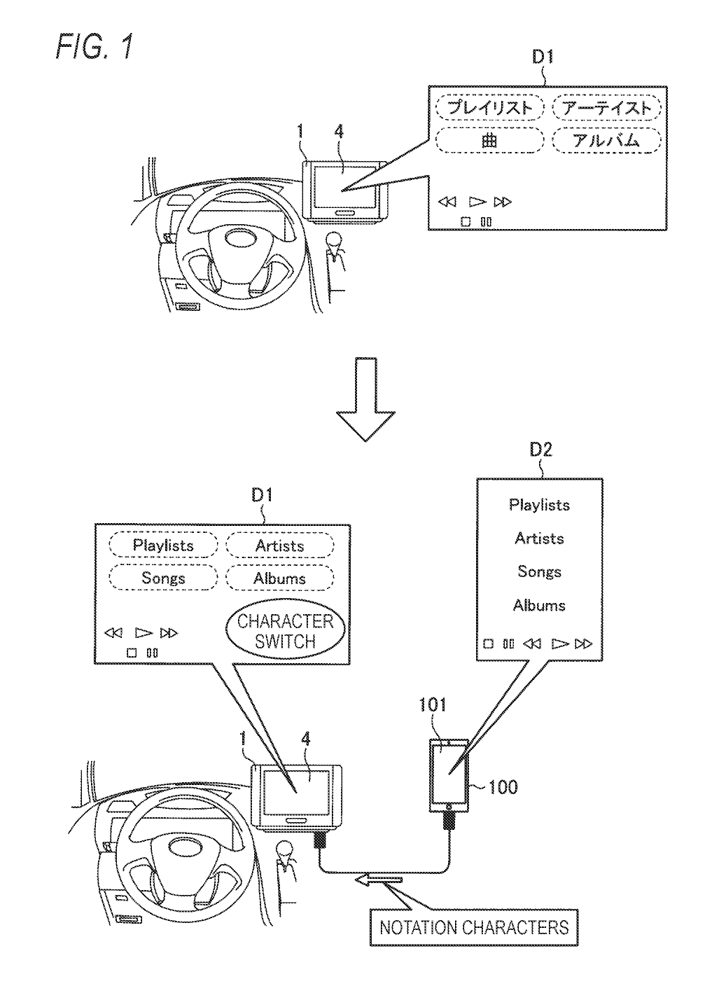

FIG. 1 is an explanatory view illustrating a menu display method of the audio device 1 according to the embodiment. As shown in FIG. 1, the audio device 1 is a device for reproducing music and the like in a vehicle, and has a touch panel type display unit 4 capable of displaying images such as a menu screen D1.

Also, the audio device 1 can be connected with a portable audio device such as a smart phone or a portable music player having an audio function, such that it is possible to operate the portable audio device by operating a menu screen which is displayed on the display unit 4. Also, the audio device 1 and a portable audio device can be connected, for example, by a USB (universal serial bus) cable or Bluetooth (a trademark) communication.

In a case where the audio device 1 is not connected with any portable audio device, the audio device displays the menu screen D1 unique to the audio device 1, on the display unit 4. The menu screen D1 includes areas where choices for selecting music to be reproduced are displayed as shown by long dotted circles in FIG. 1.

In this case, the audio device 1 displays choices “ [symbol] ” (i.e. Playlists), “ [symbol] [symbol] ” (i.e. Artists), “ [symbol] ” (i.e. Songs), and “ [symbol] ” (i.e. Albums) noted in Japanese characters (i.e. katakana or Chinese characters), on the choice display areas of the inside of the unique menu screen D1. Also, the audio device 1 displays images such as a play button, a fast-forward button, a rewind button, a pause button, and a stop button at the bottom left of the inside of the menu screen D1.

Now, an operation of the audio device 1 in a case where the audio device 1 is connected with a portable audio device 100 as shown in the lower part of FIG. 1 will be described. The portable audio device 100 has a display unit 101 capable of a menu screen D2 including choices noted in characters.

In the example shown in FIG. 1, the portable audio device 100 displays the menu screen D2 unique to the portable audio device 100, on the display unit 101. Specifically, the portable audio device 100 displays choices “Playlists”, “Artists”, “Songs”, and “Albums” noted in alphabets, inside the unique menu screen D2. Also, the portable audio device 100 displays images such as a play button, a fast-forward button, a rewind button, a pause button, and a stop button at the bottom of the inside of the menu screen D2.

As described above, the menu screen D1 unique to the audio device 1 and the menu screen D2 unique to the portable audio device 100 are the same in the meanings of the choices, but are different in the notation characters. In this case, if the menu screen D1 unique to the audio device 1 is displayed on the display unit 4 of the audio device 1, the menu screen D1 may give a feeling of strangeness to a user accustomed to the menu screen D2 unique to the portable audio device 100.

For example, in a case where the user is accustomed to the menu screen D2 can read the choices noted in alphabets and grasp their meanings, and can also intuitively understand the meanings of the choices on the basis of the character lengths and shapes of the words of the choices, the user feels discomfort about the choices of the menu screen D1.

Therefore, in order for the user unaccustomed to the menu screen D1 to operate the menu screen D1, the user needs to read the words of the choices noted in katakana or Chinese characters before operating. However, since the user cannot watch the menu screen D1 for a long time, for example, while driving the vehicle, the user feels discomfort even about operability.

However, if the portable audio device 100 is connected to the audio device 1, as shown by a left white arrow in the lower part of FIG. 1, the audio device 1 acquires the notation characters included in the menu screen D2 unique to the portable audio device 100, from the portable audio device 100.

In this case, the audio device 1 acquires the image of the menu screen D2 by acquiring data of application software for audio retained in the portable audio device 100, and also selectively acquires text data of the notation characters included in the menu screen D2. In other words, the audio device 1 acquires the notation characters included in the menu screen D2, without using any mirroring technology.

Thereafter, the audio device 1 displays the notation characters of the choices acquired from the portable audio device 100, in the choice display areas defined in the menu screen D1 unique to the audio device 1. Therefore, the menu screen D1 and the menu screen D2 are different in the choice display positions. However, in the menu screen D1, the same choices as choices which are displayed in the menu screen D2 are displayed in alphabets.

Therefore, the user accustomed to using the menu screen D2 can use the audio device 1 to operate he portable audio device 100 by operating the familiar notation characters included in the menu screen D1 of the audio device 1. Further, since the audio device 1 does not use any mirroring technology, it is possible to suppress the cost from increasing.

Also, in the case of displaying the notation characters unique to the portable audio device 100 in the menu screen D1, the audio device 1 displays a character switch button at the bottom right of the inside of the menu screen D1. In this case, if the character switch button is operated, the audio device 1 switches the displayed characters to the notation characters unique to the audio device 1.

Therefore, in a case where the user of the portable audio device 100 connected to the audio device 1 likes the notation characters unique to the audio device 1, the audio device 1 can display the notation characters according to the taste of the user, thereby capable of reducing a feeling of discomfort of the user.

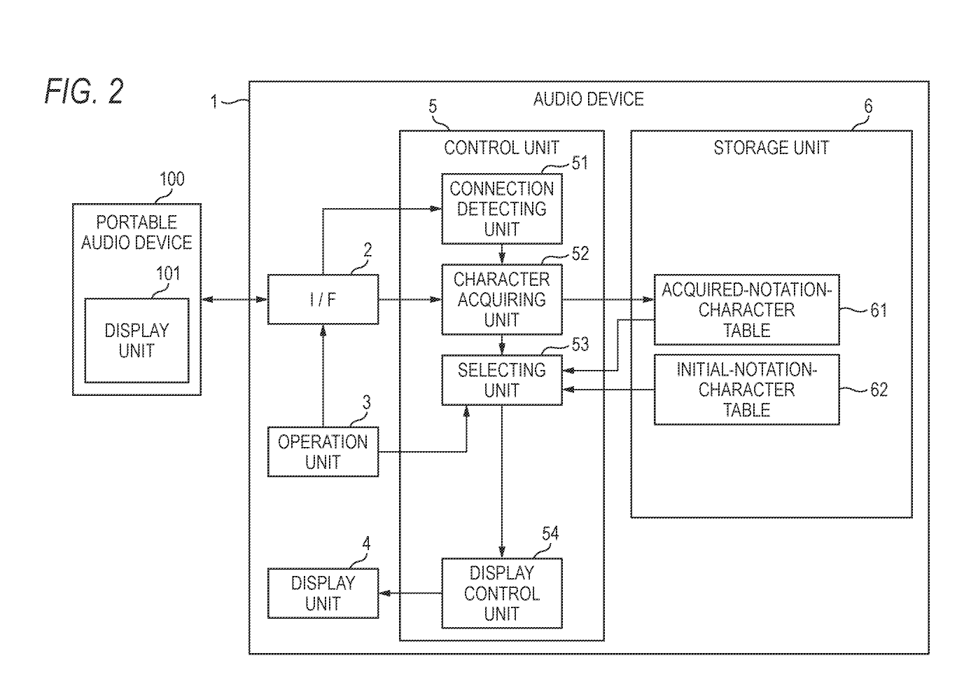

Now, the configuration and operation of the audio device 1 according to the embodiment will be described with reference to FIG. 2. FIG. 2 is a functional block diagram illustrating the configuration of the audio device 1 according to the embodiment. As shown in FIG. 2, the audio device 1 includes an interface (I/F) 2, an operation unit 3, the display unit 4, a control unit 5, and a storage unit 6.

The I/F 2 is a unit for connecting the audio device 1 and an external device, and examples of the I/F includes a USB port, a Bluetooth signal receiver, and an infrared signal receiver. The I/F 2 outputs a signal representing the connection state with an external device such as the portable audio device 100, to the control unit 5.

The operation unit 3 is a touch panel device for receiving various user's operations on the audio device 1, and outputs signals according to received operations to the I/F 2 or the control unit 5. The display unit 4 is, for example, a liquid crystal display, and displays image data input from the control unit 5. The operation unit 3 and the display unit 4 are laminated, thereby functioning as a touch panel type display operation unit.

The control unit 5 is a processing unit which includes various components such as a central processing unit (CPU), a read only memory (ROM), and a random access memory (RAM) and controls the operation of the entire audio device 1.

The control unit 5 includes a connection detecting unit 51, a character acquiring unit 52, a selecting unit 53, and a display control unit 54. The CPU reads out a predetermined operation program from the ROM, and executes the predetermined operation program while using the RAM as a work area, thereby implementing the individual units 51 to 54 of the control unit.

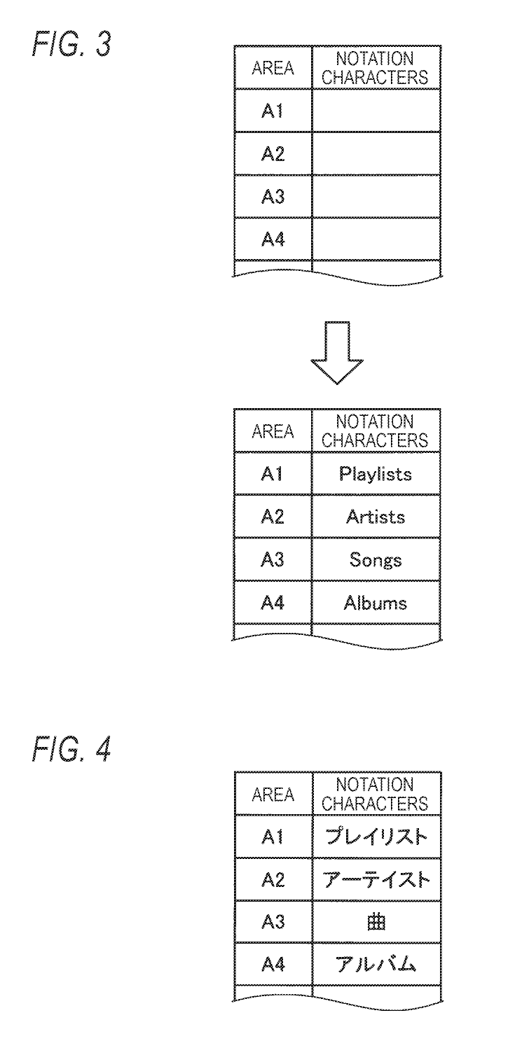

The storage unit 6 is an information storage unit such as a hard disk drive (HDD) or a flash memory, and is for storing various information such as an acquired-notation-character table 61 and an initial-notation-character table 62. Examples of the acquired-notation-character table 61 and the initial-notation-character table 62 will be described below with reference to FIGS. 3 and 4.

If the portable audio device 100 having the display unit 101 is connected to the audio device 1, on the basis of a signal input from the I/F 2, the control unit 5 determines whether a connection for communication with the portable audio device 100 has been established. In a case of determining that a connection for communication with the portable audio device 100 has been established, the connection detecting unit 51 outputs a signal representing that the connection has been established, to the character acquiring unit 52.

If the signal representing that the connection for communication with the portable audio device 100 has been established is input from the connection detecting unit 51, while the connection for communication is kept, the character acquiring unit 52 acquires the notation characters of the choices included in the menu screen D2 (see FIG. 1), from the portable audio device 100 through the I/F 2.

Thereafter, the character acquiring unit 52 outputs a signal representing that the notation characters has been acquired, to the selecting unit 53, and outputs the acquired notation characters to the storage unit 6, thereby updating the contents of the acquired-notation-character table 61. Now, a method of updating the acquired-notation-character table 61 and the initial-notation-character table 62 will be described with reference to FIG. 3.

FIG. 3 is an explanatory view of the acquired-notation-character table 61 according to the embodiment. As shown in FIG. 3, the acquired-notation-character table 61 is a table in which the choice display areas (see the long dotted circles of FIG. 1) of the menu screen D1 (see FIG. 1) unique to the audio device 1 and the notation characters to be displayed in the corresponding areas are associated with each other.

At the initial state of the acquired-notation-character table 61, as shown in the upper part of FIG. 3, storage areas for inputting notation characters are blank. Thereafter, if the character acquiring unit 52 acquires the notation characters of the choices from the portable audio device 100, it inputs the acquired notation characters into the blank notation character storage areas, thereby updating the contents of the acquired-notation-character table 61 as shown in the lower part of FIG. 3.

In an example shown in the lower part of FIG. 3, the notation characters “Playlists”, “Artists”, “Songs”, and “Albums” unique to the portable audio device 100 are associated with the areas A1, A2, A3, and A4 included in the menu screen D1, respectively.

Also, the text data of the notation characters which the character acquiring unit 52 acquires from the portable audio device 100 are, for example, serial data. At the design phrase of the audio device 1, a plurality of types of portable audio devices can be expected to be connected to the audio device 1. The contents of serial data are read from those portable audio devices and are analyzed, in advance.

Thereafter, in the character acquiring unit 52, information representing the order of notation characters included in the analyzed serial data, and information representing the correspondence relation between the read notation characters and the notation characters unique to the audio device 1 are set. On the basis of these information set in advance, the character acquiring unit 52 writes the acquired notation characters in corresponding storage areas of the acquired-notation-character table 61, thereby updating the contents of the acquired-notation-character table 61.

If the connection for communication with the portable audio device 100 is cut off, the character acquiring unit 52 initializes the acquired-notation-character table 61. In this way, the audio device 1 can efficiently use the storage areas of the storage unit 6.

However, the character acquiring unit 52 may be configured not to initialize the acquired-notation-character table 61. In this case, in a case where a connection with the portable audio device 100 is cut off, and then the portable audio device 100 is connected to the audio device 1 again, the audio device 1 can perform a process of displaying the notation characters, at high speed.

Alternatively, the character acquiring unit 52 may be configured to initialize the acquired-notation-character table 61 if a predetermined period (for example, one week) elapses after a connection for communication with the portable audio device 100 is cut off. Therefore, if the portable audio device 100 is not connected for a long period, the audio device 1 deletes the unnecessary notation characters of the portable audio device 100, thereby capable of efficiently using the storage areas of the storage unit 6.

Referring to FIG. 2 again, the selecting unit 53 is a processing unit which selects either the notation characters stored in the acquired-notation-character table 61 or the notation characters stored in the initial-notation-character table 62, and outputs the selected notation characters to the display control unit 54.

Now, an example of the initial-notation-character table 62 will be described with reference to FIG. 4. FIG. 4 is an explanatory view of the initial-notation-character table 62 according to the embodiment. As shown in FIG. 4, the initial-notation-character table 62 is a table in which the choice display areas (see the long dotted circles of FIG. 1) of the menu screen D1 (see FIG. 1) unique to the audio device 1 and the notation characters which are unique to the audio device 1 and will be displayed in the corresponding areas are associated with each other.

In an example shown in FIG. 4, the notation characters “ [symbol] ” (i.e. Playlists), “ [symbol] ” (i.e. Artists), “ [symbol] ” (i.e. Songs), and “ [symbol] ” (i.e. Albums) are associated with the areas A1, A2, A3, and A4 included in the menu screen D1, respectively.

Referring to FIG. 2 again, before the selecting unit 53 receives the signal representing that the notation characters has been acquired, from the character acquiring unit 52, the selecting unit outputs the notation characters stored in the initial-notation-character table 62, to the display control unit 54. Meanwhile, if the signal representing the notation characters has been acquired is input from the character acquiring unit 52, the selecting unit 53 outputs the notation characters stored in the acquired-notation-character table 61, to the display control unit 54.

Also, in a case where a signal representing that the character switch button has been operated is input from the operation unit 3 while the selecting unit 53 outputs the notation characters of the acquired-notation-character table 61 to the display control unit 54, the selecting unit outputs the notation characters stored in the initial-notation-character table 62, to the display control unit 54.

The display control unit 54 is a processing unit which outputs various images to the display unit 4 such that the images are displayed. In a case where the display control unit 54 controls the display unit 4 such that the display unit displays the menu screen D1, the display control unit performs control such that the display unit displays the notation characters input from the selecting unit 53, in the notation characters display areas of the menu screen D1.

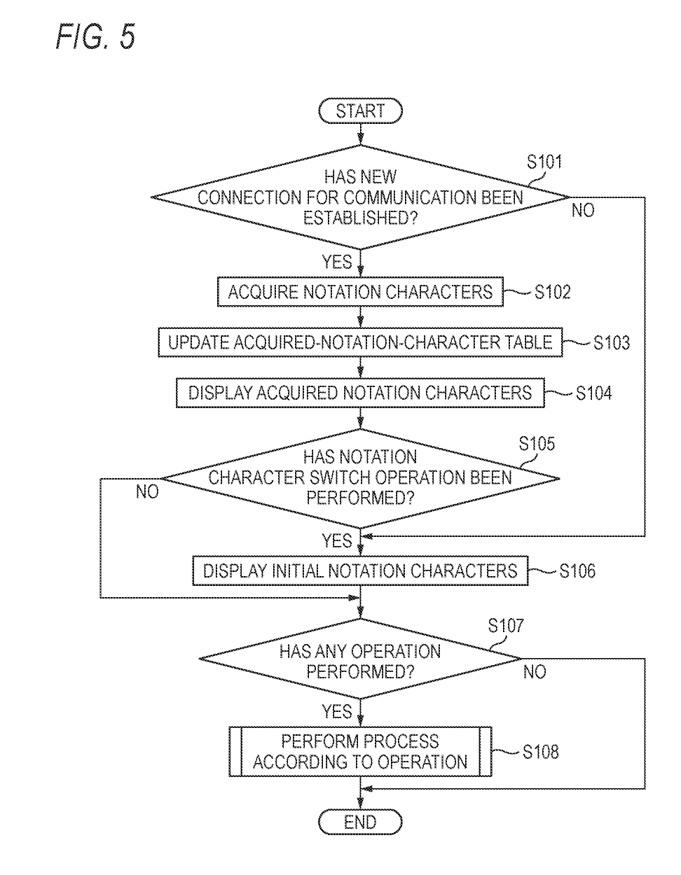

Now, a process which is performed by the control unit 5 of the audio device 1 will be described with reference to FIG. 5. FIG. 5 is a flow chart illustrating the process which is performed by the control unit 5 of the audio device 1 according to the embodiment. While the power of the audio device is on, the control unit 5 of the audio device 1 repeatedly performs the process shown in FIG. 5, at predetermined intervals.

Specifically, as shown in FIG. 5, if the audio device is powered on, first, in STEP S101, the control unit 5 determines whether a new connection for communication has been established. Here, a new connection for communication means a connection between the audio device 1 and the portable audio device 100.

In a case of determining that a new connection for communication has not been established (“No” in STEP S101), the control unit 5 advances the process to STEP S106. Also, even in a case where a connection for communication with the portable audio device 100 has been cut off, the control unit 5 determines that a new connection for communication has not been established (“No” in STEP S101), and advances the process to STEP S106.

Meanwhile, in a case of determining that a new connection for communication has been established (“Yes” in STEP S101), in STEP S102, the control unit 5 acquires the notation characters included in the menu screen D2 (see FIG. 1), from the newly connected portable audio device 100.

Subsequently, in STEP S103, the control unit 5 outputs the acquired notation characters to the storage unit 6, thereby updating the contents of the acquired-notation-character table 61. Thereafter, in STEP S104, the control unit 5 reads out the notation characters (the acquired notation characters) from the updated acquired-notation-character table 61, and controls the display unit 4 such that the display unit displays the read notation characters.

Subsequently, in STEP S105, the control unit 5 determines whether a notation character switch operation has been performed on the character switch button displayed on the display unit 4. In a case of determining that a switch operation has not been performed (“No” in STEP S105), the control unit 5 advances the process to STEP S107.

Meanwhile, in a case of determining that a switch operation has been performed (“Yes” in STEP S105), in STEP S106, the control unit 5 reads out the notation characters (the initial notation characters) from the initial-notation-character table 62, and controls the display unit 4 such that the display unit displays the read notation characters.

Thereafter, in STEP S107, the control unit 5 determines whether any operation has been performed on the operation unit 3. In this step, an operation means an operation other than a notation character switch operation, such as a song reproduction operation, a fast-forward operation, a rewind operation, a pause operation, or a stop operation.

In a case of determining that an operation has been performed (“Yes” in STEP S107), the control unit 5 performs a process according to the operation, in STEP S108, and finishes the process. Meanwhile, in a case of determining that any operation has not been performed (“No” in STEP S107), the control unit 5 finishes the process.

As described above, the audio device according to the embodiment includes the connection detecting unit, the character acquiring unit, the display unit, and the display control unit. The connection detecting unit detects establishment of a connection for communication with the portable audio device having the display unit capable of displaying choices noted in characters.

While the connection detecting unit detects establishment of a connection for communication with the portable audio device, the character acquiring unit acquires the notation characters of the choices from the portable audio device. The display control unit displays the notation characters acquired by the character acquiring unit, in the choice display areas of the display unit for displaying the menu screen.

Therefore, even in a case where the user accustomed to using the portable audio device connects the portable audio device to the audio device, the user can operate the audio device without feeling discomfort. Further, since the audio device acquires the notation characters unique to the portable audio device, from the portable audio device, and displays the notation characters, without using any mirroring technology, it is possible to suppress the cost from increasing.

Also, according to the audio device, since the audio device acquires notation characters unique to a portable audio device from the portable audio device, even if a portable audio device is expected to be connected to the audio device, it is unnecessary to store notation characters unique to the corresponding portable audio device, in advance.

Therefore, in a case where it is possible to expect connections of portable audio devices using notation characters of different languages such as English, Chinese, and Russian, it is unnecessary to store the notation characters of the multiple languages in the audio device in advance. Therefore, it is possible to reduce the cost.

Also, although the notation characters unique to the audio device and a portable audio device are the same language, different words may have the same meaning. Even in this case, since it is unnecessary to store synonyms for different portable audio devices in the audio device according to the embodiment in advance, it is possible to reduce the cost.

Also, the audio device according to the embodiment includes the storage unit for storing unique choice notation characters, and the selecting unit for selecting either the notation characters stored in the storage unit or notation characters acquired by the character acquiring unit, as notation characters to be displayed. Therefore, according to situations, the audio device can selectively display the notation characters unique to the audio device or the notation characters unique to the portable audio device.

Also, while the detecting unit detects establishment of a connection for communication, the selecting unit of the audio device according to the embodiment selects the notation characters acquired by the character acquiring unit, as notation characters to be displayed.

Therefore, in a case where the portable audio device is connected to the audio device, the audio device automatically displays the notation characters unique to the portable audio device. Therefore, the user can operate the audio device without feeling discomfort.

Also, the audio device according to the embodiment includes the operation unit for receiving a notation character switch operation of the user, and in a case where the operation unit receives a notation character switch operation while the notation characters acquired by the character acquiring unit is displayed, the selecting unit selects the notation characters stored in the storage unit, as notation characters to be displayed. Therefore, a user accustomed to the notation characters unique to the audio device than to the notation characters unique to the portable audio device can operate the audio device.

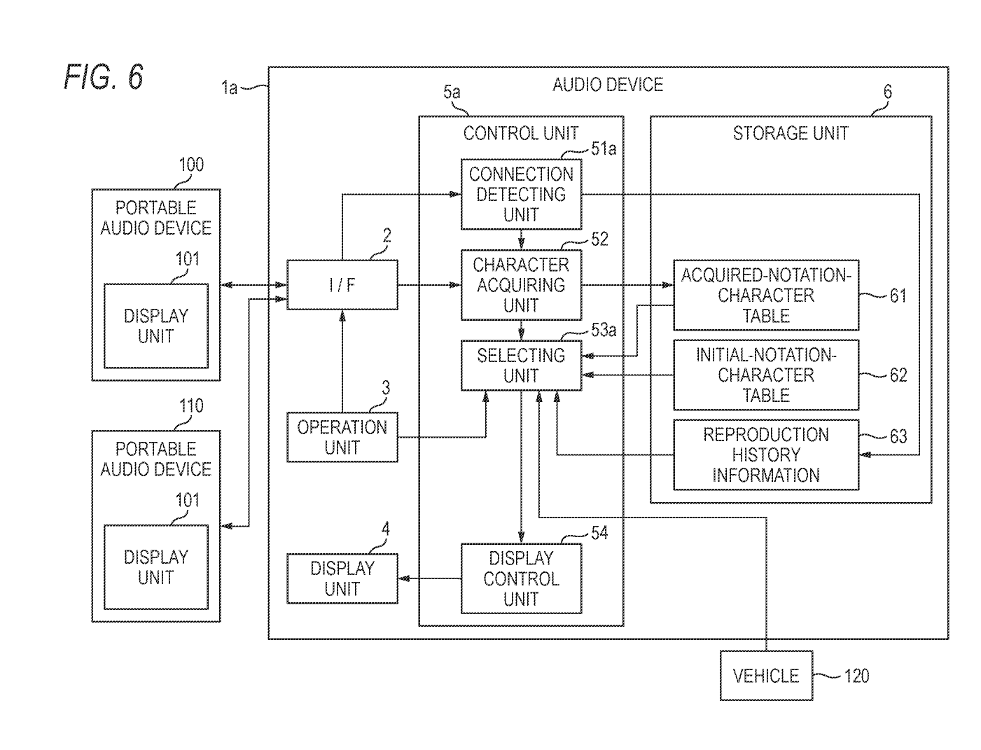

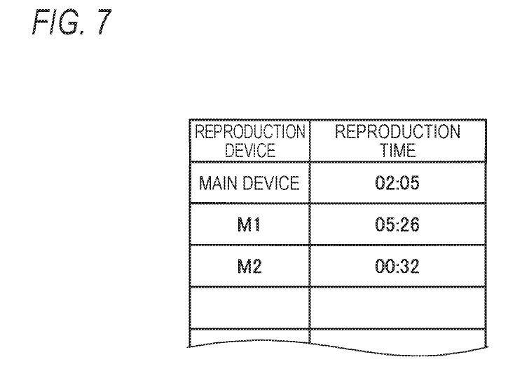

Now, an audio device 1a according to a modification of the embodiment will be described with reference to FIGS. 6 and 7. FIG. 6 is a functional block diagram illustrating the configuration of the audio device 1a according to the modification of the embodiment, and FIG. 7 is an explanatory view illustrating a reproduction history information 63 which is stored in the audio device 1a according to the audio device 1a according to the modification of the embodiment. Among components shown in FIG. 6, components identical to the components shown in FIG. 2 are denoted by the same reference symbols as the reference symbols shown in FIG. 2, and will not be described below.

As shown in FIG. 6, the audio device 1a is different from the audio device shown in FIG. 2, in that two devices of portable audio devices 100 and 110 are connected to the audio device, and a control unit 5a is connected even to a vehicle 120, and the storage unit 6 further retains the reproduction history information 63.

Also, the character acquiring unit 52 acquires notation characters unique to the portable audio devices 100 and 110, from the portable audio devices, and stores the acquired notation characters in the acquired-notation-character table 61 of the portable audio devices 100 and 110.

For this reason, processes which are performed by a connection detecting unit 51a and a selecting unit 53a are different from the processes of the connection detecting unit and the selecting unit shown in FIG. 2. However, the other configuration and operation is the same as that of the audio device shown in FIG. 2. Specifically, the connection detecting unit 51a of the audio device 1a measures the music reproduction times of the portable audio devices 100 and 110, and outputs the measured times to the storage unit 6, thereby updating the reproduction history information 63, in addition to a process of determining whether a connection for communication with each of the portable audio devices 100 and 110 has been established.

Here, the reproduction times are the cumulative music reproduction times of the audio device 1a and the portable audio devices 100 and 110. Also, the connection detecting unit 51a resets the reproduction times of the reproduction history information 63 at regular intervals. The intervals at which the connection detecting unit 51a resets the reproduction times can be set to intervals of an arbitrary period such as three months, six months, or twelve months.

Also, as shown in FIG. 7, the reproduction history information 63 is information in which the reproduction devices having reproduced music and the music reproduction times of the reproduction devices are associated with each other. In FIG. 7, “MAIN DEVICE” represents the audio device 1a, and “M1” and “M2” represent the portable audio devices 100 and 110, respectively.

If the selecting unit 53a of the audio device 1a receives a signal representing that notation characters has been acquired, from the character acquiring unit 52, the selecting unit determines the notation character priorities of the audio device 1a and the portable audio devices 100 and 110, on the basis of the reproduction history information 63.

For example, in a case where the portable audio devices 100 and 110 are connected to the audio device 1a, and the acquired-notation-character table 61 include the notation characters of the portable audio devices 100 and 110, the selecting unit 53a refers to the reproduction history information 63.

In this case, if the audio device retains the reproduction history information 63 shown in FIG. 7, the selecting unit 53a determines that the reproduction device M1 having the longest reproduction time of 5 hours and 26 minutes, that is, the portable audio device 100 has the highest priority.

In this case, the selecting unit 53a outputs the notation characters unique to the portable audio device 100 and stored in the acquired-notation-character table 61 in association with the reproduction device M1, to the display control unit 54, thereby displaying the notation characters on the display unit 4.

In other words, even in a case where the user operates any one of the portable audio devices 100 and 110 by using the audio device 1a, the selecting unit 53a selects the notation characters unique to the portable audio device 100 having the highest priority, as notation characters to be displayed. Alternatively, the selecting unit 53a may be configured to select the notation characters of any one of the portable audio devices 100 and 110, for example, according to a user's selection operation, regardless of the priorities.

According to this configuration, in a case where the plurality of portable audio devices 100 and 110 is connected to the audio device 1a, it is possible to display the notation characters unique to the portable audio device 100 which has a long music reproduction time and to which the user is most likely to be accustomed, on the display unit 4. Therefore, according to the audio device 1a, it is possible to reduce a feeling of strangeness of the user about notation characters which is displayed on the display unit 4.

Although the case where the selecting unit 53a determines the priorities of the portable audio devices 100 and 110 on the basis of the lengths of the reproduction times has been described above as an example, as a priority determination reference, an arbitrary reference such as the number of times of connection or priorities set by the user may be used.

Also, although the case where the audio device 1a acquires the notation characters unique to the portable audio devices 100 and 110 from the portable audio devices 100 and 110, and stores the acquired notation characters in the storage unit 6 has been described as an example, the audio device 1a may be configured to acquire notation characters from any one of the portable audio devices 100 and 110.

According to this configuration, for example, in a case where the portable audio device 100 is connected to the audio device 1a, the audio device 1a acquires the notation characters from the portable audio device 100, and stores the acquired notation characters in the storage unit 6. In this case, if the user performs setting such that the notation characters of the portable audio device 100 are mainly used, thereafter, even if the portable audio device 110 is connected to the audio device 1a, the audio device displays the notation characters of the portable audio device 100.

In other words, in a case where another portable audio device 110 using the choice notation characters different from the notation characters acquired by the character acquiring unit 52, the display control unit 54 of the audio device 1a controls the display unit 101 such that the display unit displays the notation characters of the portable audio device 100 stored in the storage unit 6.

However, in this configuration, the audio device 1a may be configured to control the display unit 101 such that the display unit displays the notation characters of the portable audio device 100 stored in the storage unit in a case where an audio source other than the portable audio devices 100 and 110 is reproduced.

In this case, for example, not only when another portable audio device is connected to the audio device 1a, or but also when voice stored in another audio source (such as a compact disc (CD), an internal hard disk of the audio device 1a, a flash memory, or a USB memory) is reproduced, the audio device 1a can display notation characters unique to a device and acquired first, on the menu screen.

Also, while a signal representing that the vehicle 120 is running is input from the vehicle, the selecting unit 53a prohibits switching of notation characters, and in a case where a signal representing that the vehicle 120 has stopped is input from the vehicle, the selecting unit allows switching of notation characters.

If switching of notation characters is possible while the vehicle 120 runs, the user may turn attention to switching of notation characters. However, according to the above described configuration, it is possible to prevent this situation, and thus it is possible to improve safeness. Also, with respect to whether to change the timing of switching of notation characters according to a signal which is input from the vehicle 120, it is possible to arbitrarily change setting by operating the operation unit 3.

What is claimed is:

1. An audio device comprising:
a connection detecting unit configured to detect establishment of a connection for communication with a portable audio device having a display unit capable of displaying choices noted in characters;
a character acquiring unit configured to acquire notation characters of the choices from the portable audio device while the connection detecting unit detects the establishment of the connection for communication;
a display unit configured to display a menu screen including areas for displaying choices; and
a display control unit configured to cause the display unit to display the notation characters acquired by the character acquiring unit, in the areas.

2. The audio device according to claim 1, further comprising a storage unit configured to store the notation characters acquired by the character acquiring unit,
wherein, in a case where another portable audio device using notation characters for choices, which are different from the notation characters acquired by the character acquiring unit is connected, or in a case where another audio source is reproduced, the display control unit causes the display unit to display the notation characters stored in the storage unit, in the areas.

3. The audio device according to claim 1, further comprising:
a storage unit configured to store notation characters for choices, which are unique to the audio device; and
a selecting unit configured to select either the notation characters stored in the storage unit or the notation characters acquired by the character acquiring unit, as notation characters to be displayed in the areas.

4. The audio device according to claim 3, wherein while the connection detecting unit detects the establishment of the connection for communication, the selecting unit selects the notation characters acquired by the character acquiring unit, as the notation characters to be displayed.

5. The audio device according to claim 3, further comprising an operation unit configured to receive a notation character switch operation of a user,
wherein, in a case where the operation unit receives the notation character switch operation while the notation characters acquired by the character acquiring unit are displayed, the selecting unit selects the notation characters stored in the storage unit, as the notation characters to be displayed.

6. A menu display method comprising:
detecting, by a connection detecting unit of an audio device, establishment of a connection for communication between a portable audio device having a display unit capable of displaying choices noted in characters, and the audio device having a display unit for displaying a menu screen including areas for displaying the choices;
acquiring, by a character acquiring unit of the audio device, notation characters for choices, which are unique to the portable audio device, from the portable audio device, while the connection detecting unit detects the establishment of the connection for communication; and
causing, by a display control unit of the audio device, the display device of the audio device to display the notation characters acquired by the character acquiring unit, in the areas of the display unit for displaying the menu screen.
